(19) United States
(12) Patent Application Publication
(10) Pub. No.: US 2013/0038580 A1
(43) Pub. Date: Feb. 14, 2013

(54) DISPLAY APPARATUS

(71) Applicant: Chia-Ming CHIANG, Taoyuan County (TW)

(72) Inventor: Chia-Ming CHIANG, Taoyuan County (TW)

(73) Assignee: CHUNGHWA PICTURE TUBES, LTD., TAOYUAN (TW)

(21) Appl. No.: 13/397,686

(22) Filed: Feb. 16, 2012

(30) Foreign Application Priority Data
Aug. 10, 2011 (TW) 100128559

(51) Int. Cl. G09G 5/00

(52) U.S. Cl. 345/204

(57) ABSTRACT

The invention discloses a display apparatus, which includes a display panel, a first signal wiring layer, a second signal wiring layer and a third signal wiring layer. The first signal wiring layer, the second signal wiring layer and the third signal wiring layer are disposed within a frame area around the display panel. The first signal wiring layer, the second signal wiring layer and the third signal wiring layer are located on different horizontal levels. The first signal wiring layer, the second signal wiring layer and the third signal wiring layer are used for transmitting control signals to the display panel.

### RELATED APPLICATIONS

This application claims priority to Taiwan Application Serial Number 100128559, filed Aug. 10, 2011, which is herein incorporated by reference.

### BACKGROUND

1. Field of Invention

The present invention relates to a display apparatus. More particularly, the present invention relates to a display apparatus and a signal wiring structure thereof.

2. Description of Related Art

Liquid crystal display (LCD) is popular among consumers because of their many advantages, such as compact size, low power consumption and low radiation. Therefore, LCD are widely used in electronic products, e.g., personal computer (PC) monitors, mobile phones, personal digital assistants (PDA), tablet computers, electronic books, digital televisions, etc.

In LCD, a voltage difference between two poles of a liquid crystal layer is varied for rearranging the order or direction of liquid crystal molecules within the liquid crystal layer, so as to adjust the optical transmittance of the liquid crystal layer. A backlight module radiates light through the liquid crystal layer to thereby form an image.

A display apparatus includes a display area for mounting of a display panel and a frame area around the display area. A traditional display panel usually has driver circuits including a source driver for providing data signals and a gate driver for providing scan signals. These driver circuits may drive a matrix of pixels on an LCD of the display apparatus.

Reference is made to FIG. 1, which illustrates an example of a traditional display apparatus 100. There are several vertical data lines 122 and several horizontal gate lines 124 disposed on a display area of a display panel 120 in the display apparatus 100. The data lines 122 and the gate lines 124 form a driving grid of the display apparatus 100. If an input/output (I/O) interface 140 is disposed at the lower side of the display apparatus 100, some of the signal traces responsible for transmitting a scanning signal generated by a gate driver circuit (not shown) must be extended from the I/O interface 140 along the right or left side of the display panel 120 to the gate lines 124 of the display panel 120. Accordingly, each pixel unit of the display panel 120 can be controlled based on the scanning signal, so as to display an image on the display panel 120.

With the increased resolution of the display apparatus, the total number of the gate lines on the display panel is increased, such that the frame area must be wide enough to accommodate a large number of signal traces used for scanning signals. However, the display apparatus on a portable electronic device must be compact. Therefore, to reduce the frame area while enlarging the display area as much as possible is an important goal for those working with small-sized LCD screens. Some traditional solutions are provided, such as reducing the width of signal traces or reducing the gap between adjacent signal traces. When the width of the signal traces is narrowed, however, the narrow signal traces may overheat, and in addition, the narrow signal traces are hard to manufacture. Moreover, when the gap between each adjacent pair of the signal traces is narrowed, interference between the signals transmitted on the signal traces may result. In other words, the traditional solutions have problems related to overheating, difficult manufacture, and signal quality.

### SUMMARY

In order to solve the aforesaid problems, this disclosure provides a to display apparatus utilizing three layers of signal traces on different horizontal levels within a frame area. The three layers of signal traces are overlapped or vertically offset, so as to reduce the frame width of the display apparatus. Furthermore, the three-layer structure can be realized without narrowing the width of signal traces or the gap between adjacent signal traces, such that the is signal traces of the invention can provide for greater stability in signal transmission. The signal traces of the invention are suitable for transmitting a scanning signal of a display panel from a corresponding gate driver circuit.

An aspect of the invention is to provide a display apparatus. The display apparatus includes a display panel, a first signal wiring layer, a second wiring layer and a third signal wiring layer. The first signal wiring layer is disposed within a frame area around the display panel. The second wiring layer is disposed within the frame area and located on a horizontal level different from the first signal wiring layer. The third signal wiring layer is disposed within the frame area and located on a horizontal level different from the first signal wiring layer and the second signal wiring layer. The first signal wiring layer, the second signal wiring layer and the third signal wiring layer are used for transmitting a control signal to the display panel.

According to an embodiment of the invention, the control signal further comprises a scanning control signal. The scanning control signal is generated by a gate driver circuit for controlling the display panel.

According to an embodiment of the invention, the first signal wiring layer includes a plurality of first signal traces on an identical horizontal level. The second signal wiring layer includes a plurality of second signal traces on an identical horizontal level. The third signal wiring layer includes a plurality of third signal traces on an identical horizontal level.

According to an embodiment of the invention, the first signal traces, the second signal traces and the third signal traces mutually overlap in a vertical direction.

According to an embodiment of the invention, the first signal traces, the is second signal traces and the third signal traces are located on different horizontal levels from low to high. The first signal traces and the third signal traces mutually overlap in a vertical direction. The first signal traces and the second signal traces are vertically offset.

According to an embodiment of the invention, the frame area where the three signal wiring layers are located includes at least one of four sides adjacent to the display panel.

### BRIEF DESCRIPTION OF THE DRAWINGS

The invention can be more fully understood by reading the following detailed description of the embodiment, with reference made to the accompanying drawings as follows:

FIG. 1 is a schematic diagram illustrating an example of a traditional display apparatus;

FIG. 2 is a schematic diagram illustrating a display apparatus according to an embodiment of the disclosure;

FIG. 3 is a sectional view illustrating a frame area along line A-A in FIG. 2; and

FIG. 4 is a sectional view illustrating the frame area along line A-A in FIG. 2 according to another embodiment of the invention.

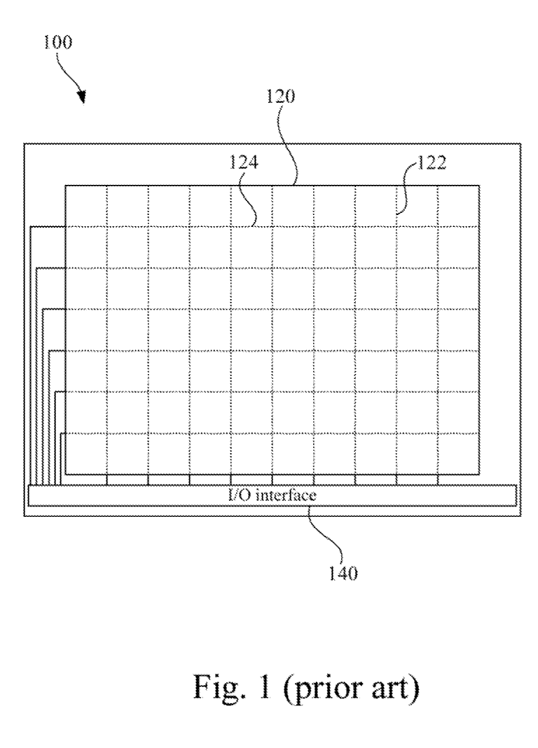

### DETAILED DESCRIPTION

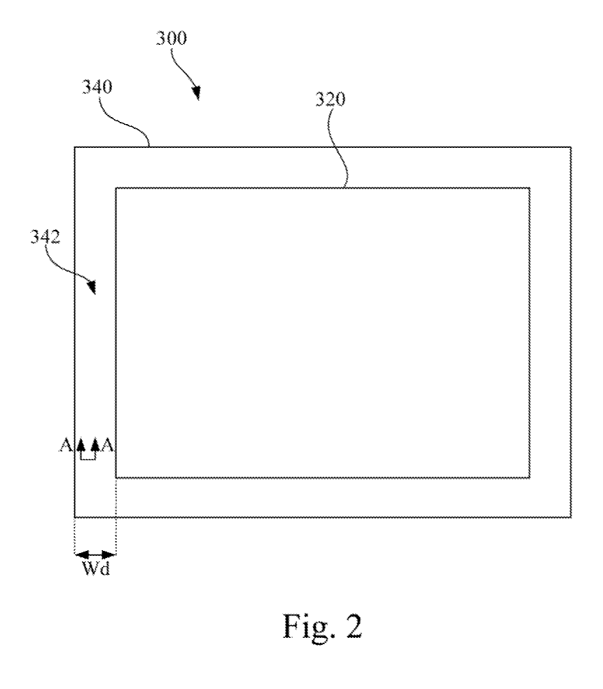

Reference is made to FIG. 2, which is a schematic diagram illustrating a display apparatus 300 according to an embodiment. In this embodiment shown in FIG. 2, the display apparatus 300 includes a display panel 320 and a frame 340.

A design of signal wiring on the frame 340 of the display apparatus 300 is disclosed in the invention. In the embodiment, a frame area 342 on the left side of the display panel 320 is used as an example for demonstration. However, the invention is not limited to use on the left side of the display panel 320.

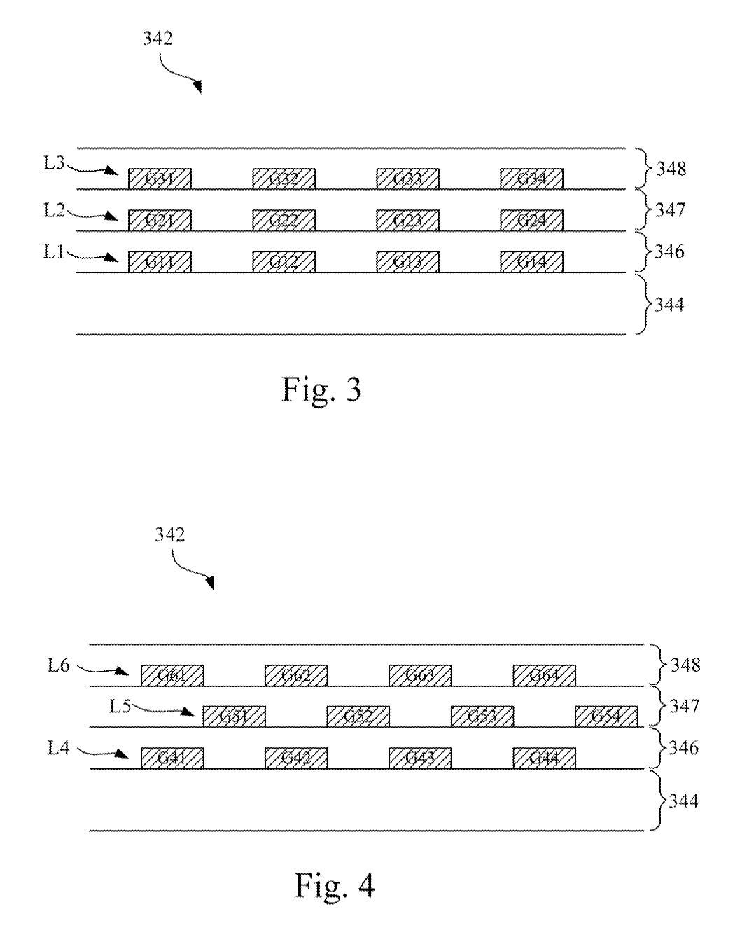

Reference is additionally made to FIG. 3, which is a sectional view illustrating the frame area 342 along line A-A in FIG. 2. As shown in FIG. 3, the bottom of the frame area 342 can be formed using a substrate 344. A first insulation layer 346, a second insulation layer 347 and a third insulation layer 348 are stacked on the substrate 344 in this sequence. In the embodiment, there are a first signal wiring layer L1, a second signal wiring layer L2 and a third signal wiring layer L3 disposed within the frame area 342 on different horizontal levels. That is, in this embodiment, the first signal wiring layer L1, the second signal wiring layer L2 and the third signal wiring layer L3 are disposed within the first insulation layer 346, the second insulation layer 347, and the third insulation layer 348 respectively.

As shown in FIG. 3, the first signal wiring layer L1 includes a plurality of first signal traces on an identical horizontal level, i.e., the first signal traces G11˜G14 in FIG. 3. The second signal wiring layer L2 includes a plurality of second signal traces on an identical horizontal level, i.e., the second signal traces G21˜G24 in FIG. 3. The third signal wiring layer L3 includes a plurality is of third signal traces on an identical horizontal level, i.e., the third signal traces G31˜G34 in FIG. 3.

The embodiment in FIG. 3 shows an overlap-type design of the first signal wiring layer L1, the second signal wiring layer and the third signal wiring layer L3. For example, the first signal trace G11, the second signal trace G21 and the third signal trace G31 mutually overlap in a vertical direction; and the first signal trace G12, the second signal trace G22 and the third signal trace G32 mutually overlap in a vertical direction.

Based on the aforesaid signal wiring design with three layers on different horizontal levels, more signal traces can be accommodated in a narrow frame width, such as the width Wd of the frame area 342 shown in FIG. 2. Compared to a single layer design in which all signal traces are located on an identical horizontal level, the embodiment may accommodate more signal traces (three times more in an ideal case) per unit of horizontal width. In this embodiment, the frame width (the width Wd shown in FIG. 2) of the frame area 342 can be reduced to ⅓ the width required when a single layer design is used.

In the embodiment, each of the signal traces G11˜G34 of the first signal wiring layer L1, the second signal wiring layer L2 and the third signal wiring. layer L3 can be used for transmitting a control signal to the display panel 320. The control signal may be a scanning control signal for a display driving function. The scanning control signal can be generated by a gate driver circuit (not shown) for controlling the display panel 320.

However, the first signal wiring layer L1, the second signal wiring layer L2 and the third signal wiring layer L3 of the invention are not limited to the overlap-type design. Reference is made to FIG. 4, which is a sectional view illustrating the frame area 342 along line A-A in FIG. 2 according to another embodiment of the invention.

As shown in FIG. 4, the first signal wiring layer L4 includes a plurality of first signal traces on an identical horizontal level, i.e., the first signal traces G41˜G44 in FIG. 4. The second signal wiring layer L5 includes a plurality of second signal traces on an identical horizontal level, i.e., the second signal traces G51˜054 in FIG. 4. The third signal wiring layer L6 includes a plurality of third signal traces on an identical horizontal level, i.e., the third signal traces G61˜G64 in FIG. 4.

The embodiment in FIG. 4 shows a vertical offset-type design of the first signal wiring layer L4, the second signal wiring layer L5 and the third signal wiring layer L6. The first signal traces G41˜G44, the second signal traces G51˜G54 and the third signal traces G61˜G64 are disposed within the frame area 342 on different horizontal levels from low to high.

The first signal traces G41˜G44 and the third signal traces G61˜G64 mutually overlap in a vertical direction. However, the second signal traces G51˜G54 are offset from the first signal traces G41˜G44 and the third signal traces G61˜G4 in a vertical direction.

For example, the first signal trace G41 and the third signal trace G61 mutually overlap. The first signal trace G42 and the third signal trace G62 mutually overlap. The second signal trace G51 is vertically offset from the first signal trace G41 and the first signal trace G42, as well as from the third signal trace G61 and the third signal trace G62, such that a vertical offset-type design is formed.

The material of signal traces is usually a metal material. A coupling capacitor will be formed between two metal signal traces when two metal traces are adjacent to each other. When two metal signal traces are too close, the impact of the coupling capacitor will be increased, and the coupling capacitor may damage the quality of signal transmission. In the embodiment, a vertical offset-type design is used for the signal traces of the first signal wiring layer L4, the second signal wiring layer L5 and the third signal wiring layer L6. Therefore, the gaps between adjacent pairs of the signal trace G41˜G64, particularly in the vertical direction, are enlarged, such that the coupling capacitor between two adjacent signal traces is reduced.

Based on the aforesaid signal wiring design with three layers on different horizontal levels, more signal traces can be accommodated in a narrow frame width (the width Wd shown in FIG. 2). Furthermore, the coupling capacitor between two adjacent signal traces can be reduced.

In the embodiment, each of the signal traces G41˜G64 of the first signal wiring layer L4, the second signal wiring layer L5 and the third signal wiring layer L6 can be used for transmitting a control signal to the display panel 320. The control signal can be a scanning control signal for a display driving function. The scanning control signal can be generated by a gate driver circuit (not shown) for controlling the display panel 320. The scanning control signal can be inputted from an input/output interface (not shown) or a driver circuit (not shown) in the display apparatus 300.

In addition, with respect to either of the embodiments shown in FIG. 3 or FIG. 4, the frame area 342 where the three signal wiring layers are located may include at least one of four sides adjacent to the display panel 320. In other words, the three layers of signal wiring structure can be utilized on the left side, the right side, the top side, or the bottom side, or on at least two sides at the same time (e.g., both the right side and the left side). The structure of multiple signal wiring layers disclosed in the invention is not limited to the left side of the frame. Furthermore, the structure of multiple signal wiring layers disclosed in the invention is not limited to three layers. The multiple signal wiring layers in the invention may include three or more layers, depending on actual requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display apparatus, comprising:
a display panel;
a first signal wiring layer disposed within a frame area around the display panel;
a second wiring layer disposed within the frame area and located on a horizontal level different from the first signal wiring layer;
a third signal wiring layer disposed within the frame area and located on a horizontal level different from the first signal wiring layer and the second signal wiring layer, wherein the first signal wiring layer, the second signal wiring layer and the third signal wiring layer are used for transmitting a control signal to the display panel.

2. The display apparatus of claim 1, wherein the control signal comprises a scanning control signal, and the scanning control signal is generated by a gate driver circuit for controlling the display panel.

3. The display apparatus of claim 1, wherein the first signal wiring layer comprises a plurality of first signal traces on an identical horizontal level, the second signal wiring layer comprises a plurality of second signal traces on an identical horizontal level, and the third signal wiring layer comprises a plurality of third signal traces on an identical horizontal level.

4. The display apparatus of claim 3, wherein the first signal traces, the second signal traces and the third signal traces mutually overlap in a vertical direction.

5. The display apparatus of claim 3, wherein the first signal traces, the second signal traces and the third signal traces are located on different horizontal levels from low to high, the first signal traces and the third signal traces mutually overlap in a vertical direction, and the first signal traces and the second signal traces are vertically offset.

6. The display apparatus of claim 1, wherein the frame area comprises at least one of four sides adjacent to the display panel.
